(19) United States
(12) Patent Application Publication
(10) Pub. No.: US 2018/0126362 A1
(43) Pub. Date: May 10, 2018

(54) HYDROTREATING CATALYST CONTAINING METAL ORGANIC SULFIDES ON DOPED SUPPORTS

(71) Applicant: Albemarle Europe SPRL, Louvain-la-Neuve (BE)

(72) Inventors: Eveline Bus, Amsterdam (NL); Upakul Deka, Utrecht (NL); Hans van der Griend, Almere (NL); Bastiaan Maarten Vogelaar, Hoofddorp (NL); Sander Hendrikus Lambertus Thoonen, Utrecht (NL); Sonja Eijsbouts-Spickova, Nieuwkuijk (NL)

(21) Appl. No.: 15/569,039

(22) PCT Filed: Apr. 25, 2016
(86) PCT No.: PCT/EP2016/059197

§ 371 Date: Oct. 24, 2017

Related U.S. Application Data
(60) Provisional application No. 62/152,382, filed on Apr. 24, 2015.

(51) Int. Cl. B01J 27/051; B01J 21/04; B01J 27/16; B01J 21/12; B01J 35/00; B01J 37/03; B01J 37/02; B01J 37/08; B01J 37/20; C10G 45/08

(52) U.S. Cl. CPC B01J 27/0515; B01J 21/04; B01J 27/16; B01J 21/12; B01J 35/0006; B01J 37/031; C10G 2300/202; B01J 37/088; B01J 37/0203; B01J 37/20; B01J 37/024; C10G 45/08; B01J 37/0236

(57) ABSTRACT

A catalyst comprising: a catalyst support; at least one Group VIB metal component; at least one Group VIII metal component; at least one mercapto-carboxylic acid; wherein the catalyst support contains at least one dopant comprising either boron, and/or silicon, and/or phosphorusin the range of about 1 to about 13 wt %, expressed as an oxide and based on the total weight of the catalyst for each dopant added; and wherein the amount of the at least one mercapto-carboxylic acid is in the amount from about 0.4 to about 3 equivalents to the sulfur amount necessary for forming sulfides of the Group VI and VIII components.

### TECHNICAL FIELD

The present invention is in the field of catalysts useful for hydrotreating hydrocarbon feedstocks in refining processes.

### THE INVENTION

In general, hydrotreating catalysts are composed of a support having deposited thereon a Group VIB (of the Periodic Table) metal component and a Group VIII (of the Periodic Table) metal component. The most commonly employed Group VIB metals are molybdenum and tungsten, while cobalt and nickel are the conventional Group VIII metals. The prior art processes for preparing these catalysts are characterized in that a support material is composited with hydrogenation metal components, for example by impregnation. Before being used in hydrotreating, the catalysts are generally presulfided to convert the hydrogenation metals into their sulfides. Processes for activating and regenerating such catalysts are also known.

However, unexpectedly, highly effective catalysts containing a unique combination of metal organic sulfides and doped supports have been discovered. In particular, it has been discovered that use of a doped support in combination with a mercapto-carboxylic acid (and metals) gives an additional activity benefit that is larger than the sum of the effect of the dopant and the effect of the mercapto-carboxylic acid.

Thus, in one embodiment of the invention there is provided a catalyst that has at least one Group VIB (of the Periodic Table) metal component, at least one Group VIII (of the Periodic Table) metal component, at least one organic compound selected from mercapto-carboxylic acids, and a boron-containing support and/or a phosphorus-containing and/or a silicon-containing support.

In another embodiment of the invention, provided is a method of producing a catalyst. The method comprises co-extruding, impregnating, and/or co-precipitating a phosphorus, and/or boron, and/or silicon source with a support to form a doped support extrudate, drying and calcining the extrudate, and impregnating the calcined extrudate with a solution comprised of at least one organic compound selected from mercapto-carboxylic acids of formula HS—R—COOH, where R is a linear or branched, and saturated or unsaturated carbon backbone (C₁-C₁₁ with or without hetero atoms such as nitrogen) with optionally a nitrogen-containing functional group such as amine or amides, at least one Group VIB metal source, at least one Group VIII metal source, and optionally also phosphorus, and optionally an additional carboxylic acid and/or other organic compound; this impregnation of the calcined extrudate can be done in one or more steps. In the process, the boron content is in the range of 0-13 wt. %, expressed as an oxide (B₂O₃) and/or a phosphorus content in the range of 0-13 wt. %, expressed as an oxide (P₂O₅), and/or a silicon content in the range of 0-13 wt % expressed as an oxide (SiO₂) and based on the total weight of the catalyst.

In another embodiment of the invention there is provided a catalyst composition formed by the just above-described process. Another embodiment of the invention is a hydrotreating process carried out employing the catalyst composition.

These and still other embodiments, advantages and features of the present invention shall become further apparent from the following detailed description, including the appended claims.

### FURTHER DETAILED DESCRIPTION OF THE INVENTION

Unless otherwise indicated, weight percent (wt %) as used herein is the weight percent of the specified form of the substance, based upon the total dry-base weight of the product for which the specified substance or form of substance is a constituent or component. It should further be understood that, when describing steps or components or elements as being preferred in some manner herein, they are preferred as of the initial date of this disclosure, and that such preference(s) could of course vary depending upon a given circumstance or future development in the art.

The Group VIB metal component in catalysts of the invention is selected from the group consisting of molybdenum, tungsten, and a mixture of the foregoing, while molybdenum is typically more preferred. The Group VIII metal component is selected from the group consisting of iron, cobalt and nickel, and a mixture of the foregoing, while nickel and/or cobalt are typically preferred. Preferred mixtures of metals include a combination of (a) nickel and/or cobalt and (b) molybdenum and/or tungsten. When hydrodesulfurisation (sometimes hereafter referred to as “HDS”) activity of the catalyst is important, a combination of cobalt and molybdenum is advantageous and typically preferred. When hydrodenitrogenation (sometimes hereafter referred to as “HDN”) activity of the catalyst is important, a combination of nickel and molybdenum and/or tungsten is advantageous and typically preferred.

The Group VIB metal compound used in the preparation can be an oxide, an oxo acid, or an ammonium salt of an oxo or polyoxo anion. Oxides and oxo acids are preferred Group VIB metal compounds. Suitable Group VIB metal compounds in the practice of this invention include but are not limited to molybdenum trioxide, molybdic acid, ammonium molybdate, ammonium para-molybdate, phosphomolybdic acid, tungsten trioxide, tungstic acid, ammonium metatungstate hydrate, ammonium para-tungstate, phosphotungstic acid and the like. Preferred Group VIB metal compounds include molybdenum trioxide, molybdic acid, tungstic acid and tungsten trioxide. The total amount of group VIB metal employed in the catalyst will typically be higher than about 10 wt %, more preferably in the range of about 18 to about 32 wt %, and most preferably in the range of about 24 to about 29 wt % (as trioxide), based on the total weight of the catalyst.

The Group VIII metal compounds used in the preparation is usually an oxide, hydroxide or salt, preferably a salt. Suitable Group VIII metal compounds include, but are not limited to, cobalt oxide, cobalt hydroxide, cobalt nitrate, cobalt carbonate, cobalt hydroxy-carbonate, cobalt acetate, cobalt citrate, nickel oxide, nickel hydroxide, nickel nitrate, nickel carbonate, nickel hydroxy-carbonate, nickel acetate, and nickel citrate. Preferred Group VIII metal compounds include cobalt carbonate, cobalt hydroxy-carbonate, nickel hydroxy-carbonate and nickel carbonate. The total amount of Group VIII metal employed in the catalyst will typically be in the range of about 2 to about 8 wt % and more preferably in the range 3 to 6 wt % (as oxide), based on the total weight of the catalyst.

In the practice of this invention, the sulfur-containing organic compound is a mercapto-carboxylic acid of formula HS—R—COOH, where R is a linear or branched, and saturated or unsaturated carbon backbone (C₁-C₁₁ with or without hetero atoms such as nitrogen) with optionally a nitrogen-containing functional group such as amine, amide, etc. Suitable examples of such mercapto-carboxylic acid include, but are not limited to, thioglycolic acid, thiolactic acid, thiopropionic acid, mercapto succinic acid, and cysteine. The amount of the mercapto-carboxylic acids to be used in accordance with the present invention is preferably 0.4 to 3 equivalents to the sulfur amount necessary for forming MoS₂/WS₂, CoS, and/or NiS, from the metals of Group VIB and VIII of the periodic table. If the amount is less than 0.4 equivalents and no second organic additive is added, a sufficient activity cannot be attained. If another carboxylic acid (without sulfur, as defined below) is used in combination with the mercapto-carboxylic acid additive, a lower amount of the mercapto-carboxylic acid can attain sufficient activity. On the other hand, if it is more than three equivalents, preparation can result in a catalyst for which activity is not enhanced. The goal of the addition of the mercapto-carboxylic acid is not to supply a stoichiometric amount of sulfur, i.e. as such to avoid pre-sulfiding. Catalysts with good activity are obtained even at lower and also at higher levels of sulfur, as compared to the stoichiometric amount necessary for forming MoS₂, WS₂, CoS and/or NiS, from the metals of Group VIB and VIII of the periodic table.

In the practice of this invention, the phosphorus component used in the support preparation and/or in the impregnation solution(s) is a compound which is typically a water soluble, acidic phosphorus compound, particularly an oxygenated inorganic phosphorus-containing acid. Examples of suitable phosphorus compounds include metaphosphoric acid, pyrophosphoric acid, phosphorus acid, orthophosphoric acid, triphosphoric acid, tetraphosphoric acid, and precursors of acids of phosphorus, such as ammonium hydrogen phosphates (mono-ammonium di-hydrogen phosphate, di-ammonium mono-hydrogen phosphate, tri-ammonium phosphate). Mixtures of two or more phosphorus compounds can be used. The phosphorus compound may be used in liquid or solid form. A preferred phosphorus compound is orthophosphoric acid (H₃PO₄) or a mono-ammonium di-hydrogen phosphate, di-ammonium mono-hydrogen phosphate, preferably in aqueous solution. If present, the amount of phosphorus employed in the catalyst will typically be higher than about 1 wt %, preferably higher than about 2 wt %, more preferably in the range of about 2 to about 10 wt %, based on the total weight of the catalyst.

The boron component used in the preparation of the support will typically be meta-boric acid (HBO₂), ortho-boric acid (H₃BO₃), ammonium borate tetra-hydrate [(NH₄)₂B₄O₇.4H₂O], sodium tetra borate, ammonium borate, ammonium tetra borate (NH₄)₂B4O7, boric oxide (B₂O₃), triethanol amine borate, ammonium tetra phenyl borate. Suitable non-limiting examples of the boron component include ortho-boric acid (H₃BO₃) and ammonium tetra borate tetra-hydrate [(NH₄)₂B₄O₇.4H₂O] and mixtures of two or more of the foregoing. The amount of boron compound should be selected in such a manner that the final support contains the desired amount of boron oxide. The amount of boron employed in the catalyst will typically be in the range of about 0 to about 13 wt %, preferably in the range of about 2 to about 8 wt %, and more preferably in the range of about 2 to about 6 wt %, expressed as an oxide (B₂O₃) based on the total weight of the catalyst.

The silicon component used in the preparation of the support will typically be sodium silicate or silicon dioxide. Other suitable silicon components include organic silicon compounds such as alkylsilanes, silicon alcoholates, straight silicone oils, modified silicone oils, and mixtures and combinations thereof. The combining of the silicon source with the alumina source may be carried out, e.g., by co-precipitation, kneading, immersion, impregnation, etc. For the incorporation, the silicon compound can also be dispersed in a solvent if need be. The amount of silicon compound should be selected in such a manner that the final support contains the desired amount of silica. The amount of silicon employed in the catalyst will typically be in the range of about 0 to about 13 wt %, preferably in the range of about 1 to about 9 wt %, expressed as an oxide (SiO₂) based on the total weight of the catalyst.

The catalyst support may comprise the conventional oxides, e.g., alumina, silica, silica-alumina, alumina with silica-alumina dispersed therein, silica-coated alumina, alumina-coated silica, magnesia, zirconia, and as well as mixtures of these oxides. As a rule, preference is given to the support being of alumina, silica-alumina, alumina with silica-alumina dispersed therein, alumina-coated silica or silica-coated alumina. A support containing a transition alumina, for example a delta, eta, theta, or gamma alumina, or combination of these is preferred within this group.

The catalyst is employed in the conventional manner in the form of, for example, spheres or extrudates. Examples of suitable types of extrudates have been disclosed in the literature (see, int. al., U.S. Pat. No. 4,028,227). Highly suitable for use are cylindrical particles (which may be hollow or not) as well as symmetrical and asymmetrical polylobed particles (2, 3 or 4 lobes).

Formation of the catalyst will normally involve at least co-precipitating, co-kneading, co-extruding, and/or impregnating a boron and/or silicon and/or phosphorus source with a support to form a doped support extrudate, drying and calcining the extrudate, and impregnating the calcined extrudate with a solution comprised of, at least one Group VIB metal source, at least one Group VIII metal source, and optionally a phosphorus component and/or mercapto carboxylic acid. The mercapto carboxylic acid additive can also be added in a second or later impregnation step.

Additional additives to the first and/or subsequent impregnation solutions may include organic additives such as
(i) an organic compound selected from the group consisting of compounds comprising at least two oxygen atoms and 2-10 carbon atoms and the compounds built up from these compounds, and/or
(ii) an organic compound comprising at least one covalently bonded nitrogen atom and at least one carbonyl moiety.

The amount of the additional organic additive(s) can be in the range of 0 to about 30 wt %, more preferably in the range of 0 to 20 wt %, based on the total dry-base weight of the catalyst. The organic compound under (i) preferably is selected from the group of compounds comprising at least two oxygen-containing moieties, such as a carboxyl, carbonyl or hydroxyl moiety, and 2-10 carbon atoms, and the compounds built up from these compounds. Organic compounds selected from the group of compounds comprising at least two hydroxyl groups and 2-10 carbon atoms per molecule and the compounds built up from these compounds are even more preferred. Examples of suitable organic compounds include carboxylic acids such as citric acid, tartaric acid, oxalic acid, malonic acid, adipic acid, and malic acid. Other suitable examples are pyruvic aldehyde, glycol aldehyde, acetaldol, and aliphatic alcohols such as butanediol, ethylene glycol, propylene glycol, glycerin, trimethylol ethane, trimethylol propane, etc. Compounds built up from these organic compounds include, e.g., the ether, ester, acetal, acid chloride, acid amide, oligomer or polymer of these organic compound. Examples of oligo- and polymers include diethylene glycol, dipropylene glycol, trimethylene glycol, triethylene glycol, tributylene glycol, tetraethylene glycol, tetrapentylene glycol. This range can be extrapolated to include, e.g., polyethers like polyethylene glycol, preferrably with a molecular weight between 200 and 8,000. Preferred organic compounds are, int. al., ethylene glycol, diethylene glycol, polyethylene glycol, or mixtures thereof. Other compounds built up from these organic compounds are, e.g., ethers such as ethylene glycol monobutyl ether, diethylene glycol monomethyl ether, diethylene glycol monoethyl ether, diethylene glycol monopropyl ether, and diethylene glycol monobutyl ether. Another group of organic compounds comprising at least two hydroxyl groups and 2-10 carbon atoms per molecule is formed by, e.g., monosaccharides such as glucose and fructose. Compounds built up from these organic compounds include oligo- and polymers, e.g., disaccharides such as lactose, maltose, and saccharose and polysaccharides. The organic compound under (ii) preferably comprises at least two carbonyl moieties. It is preferred that at least one carbonyl moiety is present in a carboxyl group. It is furthermore preferred that at least one nitrogen atom is covalently bonded to at least two carbon atoms. A preferred organic compound satisfies formula (I) or (II):

(R1R2)N—R3-N(R1′R2′) (I)

N(R1R2R1′) (II)

wherein R1, R2, R1′ and R2′ are independently selected from alkyl, alkenyl, and allyl, with up to 10 carbon atoms optionally substituted with one or more groups selected from carbonyl, carboxyl, ester, ether, amino, or amido. R3 is an alkylene group with up to 10 carbon atoms which may be interrupted by —O— or —NR4-. R4 is selected from the same group as indicated above for R1. The R3 alkylene group may be substituted with one or more groups selected from carbonyl, carboxyl, ester, ether, amino, or amido. Typical examples of a compound of formula (I) are ethylene diamine(tetra)acetic acid (EDTA), hydroxyethylene diamine triacetic acid, and diethylene triamine pentaacetic acid. A typical example of a compound of formula (II) is nitrilotriacetic acid (NTA).

The support is prepared by co-precipitating, co-kneading, and/or mixing of an alumina or silica-alumina source and the boron and/or phosphorus and/or silicon component to form an extrudable paste. If required additional heat is introduced in the process to remove additional water. The mixture is extruded in the form of spheres or extrudates, dried, and further calcined (in the presence or absence of steam) in a temperature range of 475-900° C. Optionally, an (additional) amount of boron and/or phosphorus and/or silicon is impregnated onto the calcined extrudes, optionally followed by an additional calcination step (in the presence or absence of steam) in a temperature range of 475-900° C. The exact point of addition for boron, silicon and/or phosphorus in the support preparation process is not fixed and the boron, silicon and/or phosphorus are added as a solid or solution. The resulting support material has a boron content in the range of 0-13 wt %, expressed as an oxide (B₂O₃) and/or a phosphorus content in the range of 0-13 wt % expressed as an oxide (P₂O₅) and/or a silicon content in the range of 0-13 wt. % expressed as an oxide (SiO₂) and based on the total weight of the catalyst. The total amount of dopant added to the support material is in the range of 1-26 wt %, preferably 1-20% and more preferably 1-15%. The pore volume (pV) of the thus prepared support (as measured via mercury penetration) is an important consideration since a minimum pV will be required to allow for the inclusion of the desired amount of organic compound, which in turn is determined by the amount of metals as described earlier. The pore volume of the support therefore should generally be in the range of 0.5-2 ml/g, preferably between 0.75-1 ml/g. The specific surface area, although an important consideration, is not critical to the current invention and will generally be in the range of 30-400 m²/g (measured using the BET method). The resulting extrudates can have a loss on ignition content in the range of 0-20%.

The metals, additional phosphorus, and the organic additives can be introduced onto the extrudates in one or more steps. The solutions used may or may not be heated.

For the one step approach, a solution containing at least one Group VIB metal source, at least one Group VIII metal source along with a phosphorus source in various ratios is prepared, typically using water as the solvent. Other carboxylic acids, such as citric acid, tartaric acid, oxalic acid, malonic acid, adipic acid, and malic acid may be added. The resulting solution can be acidic and have a pH in the range of 0-7. If an additive/metal ratio below about 0.5 equivalents of the sulfur amount necessary for forming MoS₂, WS₂, CoS and/or NiS is used, the solution (heated or as such) can be slowly (or dropwise) introduced as such to the support extrudates. An additional amount of the mercapto-carboxylic acid may be also added in a subsequent step. The said solution, either heated or as such, is introduced onto the support extrudates over a time period of 2-60 minutes (depending on the total amount and metal content of the catalyst) staying close to but not necessarily reaching the saturation of its pore volume. After impregnation the catalyst is allowed to age until free flowing extrudates are obtained and further aged between 60-160° C., preferably between 80-120° C. In case of using higher amounts of additives that correspond to an additive/metal ratio of above about 0.5 equivalents of the sulfur amount necessary for forming MoS₂, WS₂, CoS and/or NiS, the resulting solution might be too viscous to impregnate. Additionally, precipitation of metals/additive should be avoided. In the event of precipitation, it is not advised to filter of the precipitate to have an impregnable solution and to further impregnate this filtered solution. Viscous solutions or solutions with precipitates should be avoided by various methods known in the art. One approach could be further dilution with water (or another appropriate solvent), possibly reaching volumes much higher than the available pore volume of the support. In such a case, the solution can be added in two or more steps, with drying steps in between. Heating the solution is another common method, though excess heating in air might result in an even more viscous solution. As such, cooling or handling the solution in an inert atmosphere is considered a viable approach. The final prepared catalyst is eventually subjected to a final ageing step between 60 and 160° C., preferably between 80 and 120° C. The ageing is normally performed in air. Optionally, ageing the catalysts in an inert atmosphere could be helpful to improve physical properties (such as avoid inter-extrudate lumping) but is not crucial for the invention. Prior to the activation (pre-sulfidation) and catalytic testing, a calcination treatment at temperatures above the activation and test temperature, especially if it leads to oxidation of the sulfur component, is not preferred, because it might hamper the catalytic activity. Furthermore, any other treatment that leads to the oxidation of the sulfur component is also to be avoided.

For the multiple step approach, metals are first introduced onto the support and the mercapto-carboxylic acid additive is introduced subsequently. The metal solution may or may not be heated. The support extrudates are impregnated with a solution containing at least one Group VIB metal source, at least one Group VIII metal source along with a phosphorus source in various ratios. Other carboxylic acids, such as citric acid and those mentioned above may be added, either as part of the metal solution or in subsequent steps. Water is typically used as the solvent for preparation of the impregnation solution, while it is believed other solvents known in the art can be used. The resulting solution can be acidic and have a pH in the range of 0 and 7. The said solution is introduced onto the extrudates using 90 to 120% saturation of its pores. During the mixing/impregnation process, the catalyst is allowed to age whilst rotating to enable even mixing of all the components. The impregnated material is further dried between 80 to 150° C., preferably between 100 to 120° C., until the excess of water is removed and ‘free flowing’ catalyst extrudates are obtained. The resulting catalyst can have a moisture content in the range of 0 to 20%. Optionally, the impregnated extrudates can be calcined at temperatures up to (for example) 600° C. The mercapto-carboxylic acid is then carefully added as droplets or a continuous stream to the resulting catalysts (as a neat liquid or as a mixture with water or another appropriate solvent) over a time period of typically 2 to 60 minutes depending on the total amount of catalyst and metal content thereof. The impregnated catalyst is allowed to age until free flowing extrudates are obtained. The catalyst is then subjected to a final ageing/heat treatment step (in air or under inert atmosphere) between 60 and 160° C., preferably between 80 and 120° C. The ageing is normally performed in air. Optionally ageing the catalysts in an inert atmosphere could be helpful to improve physical properties (such as to avoid inter-extrudate lumping) but is not crucial for the invention. Prior to the activation (pre-sulfidation) and catalytic testing, a calcination treatment at temperatures above the activation and test temperature, especially if it leads to oxidation of the sulfur component, is not preferred, because it might hamper the catalytic activity. Furthermore, any other treatment that leads to the oxidation of the sulfur component is also to be avoided.

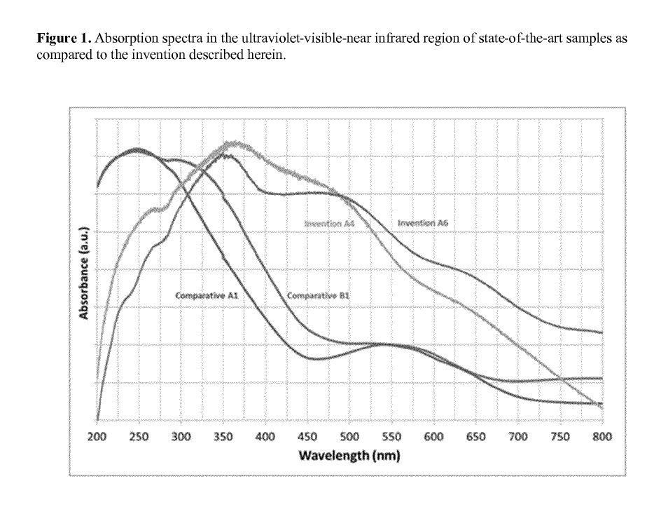

The combination of the additives with the metals on the catalyst support can result in charge transfer phenomena between the additive and the metals, which is believed to indicate their proximity and/or interaction. In most of the examples of the present invention, this can be further illustrated using various spectroscopic techniques. For example an UV-vis absorption band between about 345 to 365 nm, centered at about 355 nm, and additionally between 400 to 500 nm, (centered at about 450 nm) can be used to outline these charge transfer phenomena and differentiates the current invention from the comparative examples as presented herein. FIG. 1 illustrates the absorption spectra in the ultraviolet-visible-near infrared region to differentiate catalysts of the current invention from the comparative examples that do not contain any mercapto-carboxylic acid (and state-of-the-art) used herein. Please note here that comparatives that have mercapto-carboxylic acids as an additive will show the above mentioned spectral properties.

Apart from the activity benefit of these mercapto-carboxylic acids; the use of mercapto-carboxylic acids is beneficial because of the sulfiding properties of the final catalyst: due to the sulfur present in the compound, catalyst sulfidation is (in part) reached by the sulfur from the catalyst itself. This opens up possibilities for DMDS-lean (or feed only) or even hydrogen-only start-ups. In the context of the present specification, the phrases “sulfiding step” and/or “sulfidation step” and/or “activation step” are meant to include any process step in which at least a portion (or all) of the hydrogenation metal components present in the catalyst is converted into the (active) sulfidic form, usually after an activation treatment with hydrogen and optionally in the additional presence of a feed and/or (sulfur rich) spiking agent. Suitable sulfidation or activation processes are known in the art. The sulfidation step can take place ex situ to the reactor in which the catalyst is to be used in hydrotreating hydrocarbon feeds, in situ, or in a combination of ex situ and in situ to the reactor.

Regardless of the approach (ex situ vs in situ), catalysts described in this invention can be activated using the conventional start-up techniques known in the art. Typically, the catalyst is contacted in the reactor at elevated temperature with a hydrogen gas stream mixed with a sulfiding agent, such as hydrogen sulfide or a compound which under the prevailing conditions is decomposable into hydrogen sulfide. It is also possible to use a sulfur-containing hydrocarbon feed, without any added sulfiding agent, since the sulfur components present in the feed will be converted into hydrogen sulfide in the presence of the catalyst.

Additionally, contrary to most conventional catalysts, the catalysts described within this invention can be activated by a ‘hydrogen-only’ start-up mode, in which no additional components need to be introduced in the reactor system. Combinations of the various sulfiding techniques may also be applied. The catalyst compositions of this invention are those produced by the above-described process, whether or not the process included an optional sulfiding step.

The formed catalyst product of this invention is suitable for use in hydrotreating, hydrodenitrogenation and/or hydrodesulfurization (also collectively referred to herein as “hydrotreating”) of hydrocarbon feed stocks when contacted by the catalyst under hydrotreating conditions. Such hydrotreating conditions are temperatures in the range of 250° C.-450° C., pressure in the range of 5-250 bar, liquid space velocities in the range of 0.1-10 liter/hour and hydrogen/oil ratios in the range of 50-2000 Nl/l. Examples of suitable hydrocarbon feeds to be so treated vary widely, and include middle distillates, kerosine, naphtha, vacuum gas oils, heavy gas oils, straight run gas oil and the like.

The following examples describe the experimental preparation of the support and the catalyst, as well as use of the catalyst in hydrotreating a hydrocarbon feedstock, to illustrate activity of the catalysts so formed. This information is illustrative only, and is not intended to limit the invention in any way.

### EXAMPLES

### Preparation of the Support

The support was prepared by mixing an alumina hydrate (water content about 80%) in a kneader to form an extrudable paste. When desired, boric acid and/or phosphoric acid were added to the mix. Additionally, other acids such as nitric acid, can be used in the mixing step, the preceding precipitation step, or as peptizing agents. A person skilled in the art knows when such precipitation and peptizing agents are required. For the preparation of the silicon-containing support, sodium silicate was added in the precipitation process prior to the mixing and kneading steps. (In some cases, the water content of the extrusion mix had to be adjusted by evaporation or by adding additional water in order to obtain a paste suitable for extrusion. A person skilled in the art knows how to adjust the water content in order to obtain an extrudable paste). The resulting mixture was extruded through a die plate (of desired shapes and diameters), dried, and then calcined (optionally with steam) at a temperature in the range of 475-900° C. See Table 1 for details of the support properties. PV is pore volume. MPD is median pore diameter as determined by mercury intrusion.

TABLE 1

| | | | Weight % (of | | |
|---|---|---|---|---|---|
| | | | dopant as oxides) | | |
| | | | based on the total | | |
| | | | weight of the | PV | MPD |
| Support | Material | Dopant | support | (ml/g) | (nm) |
| S1 | γ-alumina | — | — | 0.77 | 9.3 |
| S2 | γ-alumina | Boron | 4.1 | 0.75 | 10.0 |
| S3 | γ-alumina | Boron | 3.8 | 0.81 | 10.5 |
| S4 | γ-alumina | Boron | 6.7 | 0.76 | 10.6 |
| S5 | γ-alumina | Phosphorus | 3.4 | 0.72 | 8.7 |
| S6 | γ-alumina | Boron | 8.3 | 0.78 | 10.6 |
| S7 | γ-alumina | Boron | 5.5 | 0.84 | 11.3 |
| S8 | γ-alumina | Silica | 11.8 | 0.78 | 10.1 |
| S9 | γ-alumina | Boron | 3.8 | 0.78 | 11 |

### Activity Test

The activity tests were carried out in microflow reactors using two types of extrudates. Under the first method, the catalyst extrudates were crushed and a sieve fraction between 125-310 μm was used. Under the second method, the extrudates were sized to a length of 1.4-1.8 mm. Light gas oil (LGO) spiked with dimethyl disulfide (DMDS) (total S content of 2.5 wt %) was used for pre-sulfiding the as-prepared catalysts. Vacuum gas oil (VGO) with a density of 0.93 g/ml @ 15° C., a sulfur content of 2.0 wt %, and a nitrogen content of 1600 mg/kg was used for the FCC-PT and HC-PT testing conditions. Heavy gas oil (HGO) with a density of 0.90 @ 15° C., a S content of 1.5 wt % and a N content of 542 mg/kg, was used for testing under high pressure ULSD conditions. For moderate pressure ULSD testing, a Straight Run Gas Oil (SRGO) with a density of 0.85 g/ml @ 15° C., a sulfur content of 1.31 wt. % and a nitrogen content of 121 mg/kg was used. Detailed information about test conditions is given in Tables 2, 4, and 6 and 8.

### Examples FCC-PT Application

Table 2 presents the pre-sulfiding and testing conditions for the catalysts in the different units. Table 3 lists the relative HDS and HDN activity per volume basis (RVA) and compared to the benchmark (set at 100%) for both hydrodenitrification (HDN) and hydrodesulphurization (HDS). The relative volume activities (RVA) for the various catalysts were determined as follows. For each catalyst the reaction constant kvol was calculated from the following equation: kᵥₒₗ=LHSV×(1/(n−1))×(1/Sⁿ⁻¹−1/S₀ⁿ⁻¹); in which the S stands for percentage of sulfur in the product and S₀ stands for the percentage of sulfur in the feed, and n stands for the reaction order of the hydrodesulfurization reaction (n_{HDS}). For nitrogen the kvol was calculated from the following equation: kᵥₒₗ=ln(N₀/N)×LHSV; in which the N stands for the nitrogen content in the product and N₀ for the nitrogen content in the feed. RVA is the ratio of kᵥₒₗ of the catalyst and kᵥₒₗ of the benchmark, and is expressed as a percentage. In the tables, P=pressure, LHSV=liquid hourly space velocity. Actual extrudate loading densities were used to determine LHSV. The calculations are performed in the same way regardless of the application.

The catalysts were tested in FCC-PT mode to obtain S and N-levels as low as 500 mg/kg and 600 mg/kg (for the benchmark catalyst) respectively in the condition mentioned in table 2. For the sake of comparison in FCC-PT, we use CoMo grades. We also further compare the effect of the addition of boron or silicon or phosphorus to the support in the absence of the mercapto-carboxylic acid and the effect of the addition of the mercapto-carboxylic acid in the absence of boron or silicon or phosphorus to highlight the synergistic effect of the presence of both components in this particular case. Samples (inventions) prepared on a boron doped support are compared to a benchmark prepared on a boron doped support and samples prepared on a phosphorus doped support are compared to a benchmark prepared on a phosphorus containing support.

TABLE 2
Pre-sulfiding and FCC-PT test format
Pre-sulfiding

| | | LHSV | H₂/oil | Temperature | |
|---|---|---|---|---|---|
| Feed | P (bar) | (1/hr) | (Nl/l) | (° C.) | Time (hours) |
| Spiked LGO | 45 | 3 | 300 | 320 | 24 |

Test condition

| | | LHSV | | Temperature | Time | |
|---|---|---|---|---|---|---|
| Feed | P (bar) | (1/hr) | H₂/oil (Nl/l) | (° C.) | (days) | nHDS |
| VGO | 70 | 1.20 | 400 | 360 | 12 | 1.65 |

### Example 1: Comparative A1

An impregnation solution was prepared by mixing appropriate amounts of Cobalt carbonate (CoCO₃, 46% purity), molybdenum trioxide (MoO₃) and phosphoric acid (H₃PO₄) in deionized water. The mixture was constantly stirred and kept at an appropriate temperature such as to obtain a clear solution with minimal loss of water. The initial amount of water is chosen in such a way that the resulting metal solution would have sufficient metals as compared to that desired in the final product such that no further evaporation of water is required. Having an additional amount of water is not seen as a problem, since this can be evaporated in a subsequent step.

Support S2 was impregnated with the above mentioned impregnation solution to 115% of its pore volume saturation. The thus impregnated catalyst extrudates were ‘aged’ in the rotating pan for 30 minutes at room temperature. After this, the extrudates were dried by blowing hot air (120° C., inlet) for another 30-60 minutes until free flowing extrudates are obtained. Thus, a metal impregnated dried catalysts is obtained, which is labelled as A1. The final metal content of the catalyst (dry base) was found to be 23.8 wt. % MoO₃, 4.9 wt. % CoO, 2.5 wt. % P₂O₅ and 2.9% B₂O₃.

### Example 2: Comparative A2

The catalyst was prepared in the same way as described in example 1, except that support S1 was used. The metal impregnated dried catalyst was found to have 23.0 wt. % MoO₃, 4.5 wt. % CoO and 2.1 wt. % P₂O₅. To the resulting sample, enough 2,2-dithioethanol was added such that it would fill up 80% of the available volume of the pores. The impregnated catalyst was further aged for 1 hour, while rotating. The extrudates were then poured out into a petri dish and placed in an oven at 80° C. for 16 hours. The thus obtained catalyst is labelled as A2.

### Example 3: Comparative A3

The catalyst was prepared in the same way as described in example 1 except that support S1 (without any dopant) was used in the preparation. The metal impregnated dried catalyst (dry base) was found to have 24.7 wt. % MoO₃, 4.4 wt. % CoO and 2.2 wt. % P₂O₅. The dried intermediate was further modified by adding thiolactic acid (3.5 mol/mol molybdenum present in the catalyst) in a rotating pan. Subsequently, the additive containing intermediate was further aged under blowing hot air for 1 hour, while rotating. The extrudates were then poured out into a petri dish and placed in an oven at 80° C. for 16 hours. The resulting sample was labelled A3.

### Example 4: Comparative A4

The catalyst was prepared in the same way as described in example 1 except that support S1 (without any dopant) was used in the preparation. The metal impregnated dried catalyst (dry base) was found to have 24.1 wt. % MoO₃, 4.3 wt. % CoO and 2.1 wt. % P₂O₅. The intermediate was further modified by adding thioglycolic acid (3.5 mol/mol molybdenum present in the catalyst) in a rotating pan. The additive containing intermediate was further aged under blowing hot air for 1 hour, while rotating. The extrudates were then poured out into a petri dish and placed in an oven at 80° C. for 16 hours. The resulting sample was labelled A4.

### Example 5: Comparative A5

The catalyst was prepared in the same way as described in example 1 and on the same support (S2) except that diethylene glycol (0.44 mol/mol of hydrogenation metal (Co+Mo) metals present), was added to the metal solution prior to impregnation. The resulting sample was found to have (excluding the organic additive) had 23.8 wt. % MoO₃, 4.9 wt. % CoO, 2.5 wt. % P₂O₅ and 2.9% B₂O₃. The resulting sample was labelled A5.

### Example 6: Invention A6

The catalyst was prepared in the same way as described in example 1 except that support S3 was used in the preparation. The metal impregnated dried catalyst (dry base) had 24.8 wt. % MoO₃, 4.3 wt. % CoO, 2.2 wt. % P₂O₅ and 2.9% B₂O₃, and was further modified by adding thioglycolic acid (3.5 mol/mol molybdenum present in the catalyst) in a rotating pan. The intermediate was further aged under blowing hot air for 1 hour, while rotating. The extrudates were then poured out into a petri dish and placed in an oven at 80° C. for 16 hours. The resulting sample was labelled A6.

### Example 7: Invention A7

The catalyst was prepared in the same way as described in example 1 except that support S3 was used in the preparation. The metal impregnated dried catalyst (dry base) had 24.8 wt. % MoO₃, 4.3 wt. % CoO, 2.2 wt. % P₂O₅ and 2.9% B₂O₃, and was further modified by adding thiolactic acid (3.5 mol/mol molybdenum present in the catalyst) in a rotating pan. The intermediate was further aged for 1 hour under blowing hot air, while rotating. The extrudates were then poured out into a petri dish and placed in an oven at 80° C. for 16 hours. The resulting sample was labelled A7.

### Example 8: Invention A8

The catalyst was prepared in the same way as illustrated in example 1, except for two differences: support S5 was used; diethylene glycol (0.44 mol/mol of hydrogenation (Co+Mo) metals present), was added to the metal solution prior to impregnation. The resulting sample (excluding the organic additive) was found to have 18.7 wt. % MoO₃, 3.4 wt. % CoO and 4.2 wt. % P₂O₅. This is labelled as A8.

### Example 9: Invention A9

The catalyst was prepared in the same way as described in example 1 except that support S5 was used in the preparation. The metal impregnated dried catalyst (dry base) was found to have 22.4 wt. % MoO₃, 4 wt. % CoO and 4.3 wt. % P₂O₅, and was further modified by adding thioglycolic acid (3.5 mol/mol molybdenum present in the catalyst) in a rotating pan. The intermediate was further aged for 1 hour, while rotating. The extrudates were then poured out into a petri dish and placed in an oven at 80° C. for 16 hours. The resulting sample was labelled A9.

### Example 10: Invention A10

The catalyst was prepared in the same way as described in example 1 except that support S5 was used in the preparation. The metal impregnated dried catalyst (dry base) was found to have 22.4 wt. % MoO₃, 4 wt. % CoO and 4.3 wt. % P₂O₅, and was further modified by adding thiolactic acid (3.5 mol/mol molybdenum present in the catalyst) in a rotating pan. The intermediate was further aged for 1 hour, while rotating. The extrudates were then poured out into a petri dish and placed in an oven at 80° C. for 16 hours. The resulting sample was labelled A10.

TABLE 3
The effect of the addition of a support dopant and further
a mercapto-carboxylic acids in the activity of
supported CoMo catalysts in the FCC-PT application.

| | | | | RVA | RVA | |
|---|---|---|---|---|---|---|
| Example | Support | Additive | Test | HDN | HDS | Benchmark |
| Comparative | S2 | None | crushed | 100% | 100% | A1 |
| A1 | | | | | | |
| Comparative | S1 | 2.2′-dithioethanol | crushed | 119% | 141% | A1 |
| A2 | | | | | | |
| Comparative | S1 | Thiolactic acid | crushed | 127% | 146% | A1 |
| A3 | | | | | | |
| Comparative | S1 | Thioglycolic acid | crushed | 134% | 151% | A1 |
| A4 | | | | | | |
| Comparative | S2 | Di ethylene glycol | crushed | 124% | 132% | A1 |
| A5 | | | | | | |
| Invention A6 | S3 | Thioglycolic acid | crushed | 141% | 156% | A1 |
| Invention A7 | S3 | Thiolactic acid | crushed | 149% | 165% | A1 |
| Comparative | S5 | Di ethylene glycol | extrudates | 100% | 100% | A8 |
| A8 | | | | | | |
| Invention A9 | S5 | Thioglycolic acid | crushed | 146% | 119% | A8 |
| Invention A10 | S5 | Thiolactic acid | crushed | 131% | 119% | A8 |

### Examples HC-PT Application

Table 4 presents the pre-sulfiding and testing conditions. For the sake of comparison in HC-PT, we use NiMo grades. The benchmark contains a boron-containing support. Comparison is made between samples with similar metal loadings. The catalyst comparison is presented at nitrogen and sulfur levels of 60 mg/kg N and 190 mg/kg S (for the reference catalyst). Table 5 lists the relative HDS and HDN activity per volume basis (RVA) and compared to the benchmark (set at 100%) for both hydrodenitrification (HDN) and hydrodesulphurization (HDS).

TABLE 4
Pre-sulfiding and HC-PT test format of Standard Extrudate runs.
Pre-sulfiding

| | | LHSV | H₂/oil | Temperature | |
|---|---|---|---|---|---|
| Feed | P (bar) | (1/hr) | (Nl/l) | (° C.) | Time (hours) |
| Spiked LGO | 45 | 3 | 300 | 320 | 29 |

Test condition

| | | | | | Time on | |
|---|---|---|---|---|---|---|
| | | LHSV | | Temperature | stream | |
| Feed | P (bar) | (1/hr) | H₂/oil (Nl/l) | (° C.) | (days) | nHDS |
| VGO | 120 | 1.7 | 1000 | 380 | 35 | 1.1 |

### Example 11: Comparative B1

An impregnation solution was prepared by mixing appropriate amounts of Nickel carbonate (NiCO₃, 49% purity), molybdenum trioxide (MoO₃) and phosphoric acid (H₃PO₄) in deionized water. The mixture was constantly stirred and kept at an appropriate temperature such as to obtain a clear solution with minimal loss of water. The initial amount of water is chosen in such a way that the resulting metal solution would have sufficient metals as compared to that desired in the final product such that no further evaporation of water is required. To this metal solution diethylene glycol (0.44 mol/mol of hydrogenation metals present), was added.

Support S4 was impregnated with the above mentioned impregnation solution to 115% of its pore volume saturation. The thus impregnated catalyst extrudates were ‘aged’ in the rotating pan for 30 minutes at room temperature. After this, the extrudates were dried by blowing hot air (120° C., inlet) for another 30-60 minutes until free flowing extrudates are obtained. Thus, a metal impregnated dried catalyst is obtained, which is labelled as B1. The final metal content of the catalyst (dry base, excluding organics) was found to be 24 wt. % MoO₃, 3.8 wt. % NiO, 6.8 wt. % P₂O₅ and 4.5 wt. % B₂O₃.

### Example 12: Invention B2

Catalyst B2 was made in the same way as described in example 11, except that no diethylene glycol was added to the metal solution and support S6 was used. The metal impregnated catalyst (dry base) was found to have 24 wt. % MoO₃, 3.8 wt. % NiO, 7.1 wt. % P₂O₅ and 5.6 wt. % B₂O₃ and was further modified by adding thioglycolic acid (3.5 mol/mol molybdenum present in the catalyst) in a rotating pan. The intermediate was further aged for 1 hour, while rotating. The extrudates were then poured out into a petri dish and placed in a static oven at 80° C. for 16 hours. The resulting sample was labelled B2.

### Example 13: Comparative B3

The catalyst was prepared in the same way as described in example 11, however to end up with a higher metal content. The metal impregnated dried catalyst (excluding organics) was found to have 25.9 wt. % MoO₃, 4.1 wt. % NiO, 7.2 wt. % P₂O₅ and 4.4% B₂O₃. The resulting sample was labelled B3.

### Example 14: Invention B4

Catalyst B4 was made in the same way as described in example 12, however with lower amount of TGA (1.75 mol/mol molybdenum present in the catalyst) and to end up with a higher metal content. The metal impregnated catalyst (dry base) was found to have 26 wt. % MoO₃, 4.1 wt. % NiO, 7.6 wt. % P₂O₅ and 4.9 wt. % B₂O₃. The resulting sample was labelled B4.

### Example 15: Invention B5

The catalyst was prepared in the same way as described in example 11, except that citric acid (instead of diethylene glycol) was added to the metal solution (0.14 mol/mol of hydrogenation metals present) and support S7 was used for impregnation of the said solution. The metal impregnated catalyst (dry base) was found to have 25.9 wt. % MoO₃, 4.3 wt. % NiO, 7.1 wt. % P₂O₅ and 3.5 wt. % B₂O₃ and was further modified by adding thioglycolic acid (1 mol/mol molybdenum present in the catalyst) in a rotating pan. The intermediate was further aged for 1 hour, while rotating. The extrudates were then poured out into a petri dish and placed in a static oven at 80° C. for 16 hours. The resulting sample was labelled B5.

### Example 16: Invention B6

The catalyst was prepared in the same way as described in example 11, except that citric acid was also added to the metal solution (0.14 mol/mol of hydrogenation metals present) and support S9 was used for impregnation of the said solution. The metal impregnated catalyst (dry base) was found to have 26.2 wt. % MoO₃, 4.1 wt. % NiO, 7.2 wt. % P₂O₅ and 2.6 wt. % B₂O₃ and was further modified by adding thioglycolic acid (1 mol/mol molybdenum present in the catalyst) in a rotating pan. The intermediate was further aged for 1 hour, while rotating. The extrudates were then poured out into a petri dish and placed in a static oven at 80° C. for 16 hours. The resulting sample was labelled B6.

TABLE 5
The effect of the addition of a support dopant and
further a mercapto-carboxylic acids in the activity of
supported NiMo catalysts in the HC-PT application.

| | | | | RVA | RVA | |
|---|---|---|---|---|---|---|
| Example | Support | Additive | Test | HDN | HDS | Benchmark |
| Comparative | S4 | Di ethylene glycol | extrudates | 100% | 100% | B1 |
| B1 | | | | | | |
| Invention B2 | S6 | Thio glycolic acid | extrudates | 123% | 113% | B1 |
| Comparative | S4 | Di ethylene glycol | extrudates | 100% | 100% | B3 |
| B3 | | | | | | |
| Invention B4 | S6 | Thio glycolic acid | extrudates | 133% | 118% | B3 |
| Invention B5 | S7 | Citric acid + thio | extrudates | 125% | 118% | B3 |
| | | glycolic acid | | | | |
| Invention B6 | S9 | Diethylene glycol + | crushed | 108% | 111% | B3 |
| | | citric acid + thio glycolic | | | | |
| | | acid | | | | |

### Examples High-Pressure ULSD Application

The catalysts were tested in a multi-test unit under ultra-low sulfur diesel conditions. Table 6 lists the pre-sulfidation and testing condition used for the comparison. The four catalysts presented are NiMo grades with comparable metal loadings and are based on two different supports. Table 7 shows the activity results.

TABLE 6
Pre-sulfiding and high pressure ULSD
test format of Standard Extrudate runs.
Pre-sulfiding

| | | LHSV | H₂/oil | Temperature | |
|---|---|---|---|---|---|
| Feed | P (bar) | (1/hr) | (Nl/l) | (° C.) | Time (hours) |
| Spiked LGO | 45 | 3 | 300 | 320 | 24 |

Test condition

| | | | | | Time on | |
|---|---|---|---|---|---|---|
| | | LHSV | | Temperature | stream | |
| Feed | P (bar) | (1/hr) | H₂/oil (Nl/l) | (° C.) | (days) | nHDS |
| HGO | 80 | 1.75 | 500 | 341 | 14 | 1.05 |

### Example 17: Comparative C1

Comparative C1 was prepared on support S4 in the same way as described in example 11, except a higher amount of diethylene glycol (1 mol/mol of hydrogenation metals) and metals were used. The final metal composition of the catalyst (dry base, excluding organics) was 28.9 wt. % MoO₃, 4.7 wt. % NiO, 3.2 wt. % P₂O₅ and 4.7% B₂O₃.

### Example 18: Invention C2

Invention C2 was prepared on support S4 in the same way as illustrated in example 17, except no diethylene glycol was added to the metal solution. The composition of the metal impregnated dried catalyst (dry base) was 28.9 wt. % MoO₃, 4.6 wt. % NiO, 3.2 wt. % P₂O₅ and 4.7% B₂O₃ and was further modified by adding thioglycolic acid (1 mol/mol total hydrogenation metals in the catalyst) in a rotating pan. The intermediate was further aged for 1 hour, while rotating. The extrudates were then poured out into a petri dish and placed in a static oven at 80° C. for 16 hours. The resulting sample was labelled C2.

### Example 19: Comparative C3

Comparative C3 was prepared in the same way as illustrated in example 17, except support S8 was used instead. The final metal composition of the catalyst (dry base, excluding organics) was 28.5 wt. % MoO₃, 4.5 wt. % NiO, 3 wt. % P₂O₅ and 8 wt. % SiO₂.

### Example 20: Invention C4

The catalyst was produced in the same way as illustrated in example 18, except support S8 was used instead. The final metal composition of the catalyst (dry base, excluding organics) was 28.8 wt. % MoO₃, 4.5 wt. % NiO, 2.8 wt. % P₂O₅ and 7.7 wt. % SiO₂.

TABLE 7
The effect of the addition of a dopant and further
a mercapto-carboxylic acids in the activity of
supported NiMo catalysts in the HP-ULSD application.

| | | | | RVA | RVA | Bench- |
|---|---|---|---|---|---|---|
| Example | Support | Additive | Test | HDN | HDS | mark |
| Comparative | S4 | Diethylene | Extrudates | 100% | 100% | C1 |
| C1 | | glycol | | | | |
| Invention C2 | S4 | Thioglycolic | Extrudates | 113% | 125% | C1 |
| | | acid | | | | |
| Comparative | S8 | Diethylene | Extrudates | 100% | 100% | C3 |
| C3 | | glycol | | | | |
| Invention C4 | S8 | Thioglycolic | Extrudates | 113% | 132% | C3 |
| | | acid | | | | |

### Examples Moderate Pressure ULSD Application

The catalysts were tested in a multi-test unit under medium pressure ultra-low sulfur diesel conditions. The four catalysts presented are CoMo grades with comparable metal loadings and are based on two different supports. Table 8 shows the pre-sulfidation and activity results and Table 9 shows the activity results.

TABLE 8
Pre-sulfiding and MP-ULSD test format of Standard Extrudate runs.
Pre-sulfiding

| | | LHSV | H₂/oil | Temperature | |
|---|---|---|---|---|---|
| Feed | P (bar) | (1/hr) | (Nl/l) | (° C.) | Time (hours) |
| Spiked LGO | 45 | 3 | 300 | 320 | 24 |

Conditions

| | | | | H₂/ | Tem- | Time on | |
|---|---|---|---|---|---|---|---|
| | | P | LHSV | oil | perature | stream | |
| Condition | Feed | (bar) | (1/hr) | (Nl/l) | (° C.) | (days) | nHDS |
| 1 | SRGO | 45 | 4 | 200 | 350 | 6 | 1 |

### Example 21: Comparative D1

Comparative D1 was prepared in the same way as described in example 5, except that Support S1 was used in the preparation, and an additional amount of citric acid was included in the metal solution (0.07 mol/mol of hydrogenation metals). The final metal composition of the catalyst (dry base, excluding organics) was 24.1 wt. % MoO₃, 4.2 wt. % CoO and 2.1 wt. % P₂O₅.

### Example 22: Comparative D2

Comparative D2 was prepared in the same way and on the same support as example 21, except no diethylene glycol was added to the metal solution. The composition of the metal impregnated dried catalyst (dry base) was 24.1 wt. % MoO₃, 4.2 wt. % CoO and 2.1 wt. % P₂O₅ and was further modified by adding thioglycolic acid (1 mol/mol total hydrogenation metals in the catalyst) in a rotating pan. The intermediate was further aged for 1 hour, while rotating. The extrudates were then poured out into a petri dish and placed in a static oven at 80° C. for 16 hours. The resulting sample was labelled D2.

### Example 23: Comparative D3

Comparative D3 was prepared in the same way as described in example 21, except that Support S2 was used in the preparation, and no citric acid was included in the metal solution. The final metal composition of the catalyst (dry base, excluding organics) was 24.1 wt. % MoO₃, 4.1 wt. % CoO, 2 wt. % P₂O₅ and 3 wt. % B₂O₃. The resulting catalyst was labelled D3.

### Example 24: Invention D4

Invention D4 was in the same way and on the same support as example 23, except no diethylene glycol was added to the metal solution. The composition of the metal impregnated dried catalyst (dry base) was 24.1 wt. % MoO₃, 4.1 wt. % CoO, 2 wt. % P₂O₅ and 3 wt. % B₂O₃ and was further modified by adding thioglycolic acid (1 mol/mol total hydrogenation metals in the catalyst) in a rotating pan. The intermediate was further aged for 1 hour, while rotating. The extrudates were then poured out into a petri dish and placed in a static oven at 80° C. for 16 hours. The resulting sample was labelled D4.

TABLE 9
The effect of the addition of a dopant and further
a mercapto-carboxylic acids in the activity of
supported NiMo catalysts in the MP-ULSD application

| | | | | RVA | RVA | Bench- |
|---|---|---|---|---|---|---|
| Example | Support | Additive | Test | HDN | HDS | mark |
| Comparative | S1 | Diethylene | Extrudates | 100% | 100% | D1 |
| D1 | | glycol + | | | | |
| | | citric acid | | | | |
| Invention D2 | S1 | Thioglycolic | Extrudates | 121% | 106% | D1 |
| | | acid + | | | | |
| | | citric acid | | | | |
| Comparative | S2 | Diethylene | Extrudates | 103% | 85% | D1 |
| D3 | | glycol | | | | |
| Invention D4 | S2 | Thioglycolic | Extrudates | 206% | 143% | D1 |
| | | acid | | | | |

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent or other publication or published document referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

1. A catalyst comprising:
a catalyst support;
at least one Group VIB metal component;
at least one Group VIII metal component;
at least one mercapto-carboxylic acid;
wherein the catalyst support contains at least one dopant comprising either boron, and/or silicon, and/or phosphorus in the range of about 1 to about 13 wt %, expressed as an oxide and based on the total weight of the catalyst for each dopant added; and
wherein the amount of the at least one mercapto-carboxylic acid is in the amount from about 0.4 to about 3 equivalents to the sulfur amount necessary for forming sulfides of the Group VI and VIII components.

2. The catalyst according to claim 1 wherein the Group VIB metal component comprises molybdenum and/or tungsten.

3. The catalyst according to claim 1 or 2 wherein the Group VIII metal component comprises nickel and/or cobalt.

4. The catalyst according to any one of claims 1-3 wherein the mercapto-carboxylic acid is thioglycolic acid, thiolactic acid, mercapto succinic acid, cysteine or thio propionic acid.

5. The catalyst according to claim 4 further comprising an additional carboxylic acid.

6. The catalyst according to any one of claims 1-5, wherein the dopant is boron in the range of about 2 wt % to about 8 wt %, expressed as an oxide (B₂O₃) and based on the total weight of the catalyst.

7. The catalyst according to any one of claims 1-5, wherein the dopant is phosphorus in the range of about 2 wt % to about 10 wt %, expressed as an oxide (P₂O₅) and based on the total weight of the catalyst.

8. The catalyst according to claims any one of 1-5, wherein the dopant is silicon in the range of about 1 wt % to about 9 wt %, expressed as an oxide (SiO₂) and based on the total weight of the catalyst.

9. The catalyst according to claim 6, 7, or 8 wherein the catalyst support is impregnated with the Group VIB metal component, the Group VIII metal component, and the mercapto-carboxylic acid.

10. The catalyst according to claim 9 wherein the catalyst support is further impregnated with a phosphorous component.

11. The catalyst according to any of the preceding claims, wherein the catalyst support comprises alumina.

12. A method of producing a catalyst, the method comprising:
forming a doped catalyst support having a boron, and/or silicon and/or phosphorus content in the range of about 1 wt % to about 13 wt % for each dopant added, expressed as an oxide and based on the total weight of the catalyst;
drying and calcining the catalyst support;
impregnating the calcined catalyst support with a solution comprised of a mercapto-carboxylic acid, at least one Group VIB metal source and/or at least one Group VIII metal source, wherein the amount of the mercapto-carboxylic acid is at least 0.4 to 3 equivalents to the sulfur amount necessary for forming sulfides of the Group VI and VIII components; and
ageing the impregnated catalyst support for a period of time between 60 and 160° C.

13. A method of producing a catalyst, the method comprising
forming a doped catalyst support having a boron, and/or silicon and/or phosphorus content in the range of about 1 wt % to about 13 wt % for each dopant added, expressed as an oxide and based on the total weight of the catalyst;
drying and calcining the catalyst support;
impregnating the calcined catalyst support with a solution comprised of at least one Group VIB metal source and/or at least one Group VIII metal source;
drying the impregnated catalyst support at 80-150° C.;
further impregnating the dried impregnated catalyst support with an amount of a mercapto-carboxylic acid wherein the amount of the mercapto-carboxylic acid is at least 0.4 to 3 equivalents to the sulfur amount necessary for forming sulfides of the Group VI and VIII components; and
ageing the impregnated catalyst support for a period of time between 60 and 160° C.

14. The method according to claim 12 or 13, wherein the amount of the boron component source is sufficient so that the boron content of the catalyst produced is in the range of about 2 wt % to about 8 wt %, expressed as an oxide (B₂O₃) and based on the total weight of the catalyst.

15. The method according to claim 12 or 13, wherein the phosphorus component source is sufficient so that the phosphorus content in the catalyst produced is in the range of about 2 wt % to about 10 wt %, expressed as an oxide (P₂O₅) and based on the total weight of the catalyst.

16. The method according to claim 12 or 13, wherein the silicon component source is sufficient so that the silicon content in the catalyst produced is in the range of about 2 wt % to about 9 wt %, expressed as an oxide (SiO₂) and based on the total weight of the catalyst.

17. The method according to any one of claims 12-16 wherein the mercapto-carboxylic acid is thioglycolic acid, thiolactic acid, mercapto succinic acid, cysteine or thio propionic acid.

18. The method according to any one of claims 12-16 further comprising impregnating the extrudate with a carboxylic acid.

19. A catalyst formed in accordance with any one of claims 12-18.

20. A method which comprises contacting a hydrocarbon feed with a catalyst according to any of the preceding claims, under hydrotreating conditions so as to hydrotreat the hydrocarbon feed.

21. A method which comprises contacting a hydrocarbon feed with a catalyst according to any of the preceding claims, under hydrotreating conditions so as to hydrotreat the hydrocarbon feed, wherein the catalyst is activated without the addition of additional sulfur compounds.
